(19) United States
(12) Patent Application Publication
(10) Pub. No.: US 2008/0096023 A1
(43) Pub. Date: Apr. 24, 2008

(54) PROCESS FOR PREPARING COATED OPTICAL ELEMENTS

(75) Inventors: James P. Colton, Trafford, PA (US); Brandy D. Slezak, Export, PA (US)

Correspondence Address: Deborah M. Altman;PPG Industries, Inc., Law Department - Intellectual Property, One PPG Place - 39th Floor, Pittsburgh, PA, 15272-0001, US

(73) Assignee: PPG INDUSTRIES OHIO, INC., Cleveland, OH (US)

(21) Appl. No.: 11/685,965

(22) Filed: Mar. 14, 2007

Related U.S. Application Data
(63) Continuation-in-part of application No. 11/583,594, filed on Oct. 18, 2006.

(51) Int. Cl. B05D 3/00; B32B 9/00

(52) U.S. Cl. 428/411.1; 427/299; 427/322

(57) ABSTRACT

A process is provided for preparing a coated optical element. The process Includes:
a) providing an optical element substrate;
b) contacting the optical element with a pretreatment composition of an aqueous solution of hydrolyzed aminosilane; and
c) applying a film-forming composition to the optical element of (b) to form a coating on the optical element, thereby yielding a coated optical element. The pretreatment composition may further include a substantially water-miscible solvent that is capable of swelling the substrate surface without causing haze or degradation of the substrate. The coated optical element demonstrates improved adhesion between the film-forming composition and the substrate compared to a substantially identical optical element that has not been contacted with the pretreatment composition of step b) prior to application of the film-forming composition.

### CROSS REFERENCE TO RELATED APPLICATIONS

This application is a continuation-in-part of U.S. patent application Ser. No. 11/583,594, filed Oct. 18, 2006.

### FIELD OF THE INVENTION

The present invention relates to processes for preparing coated optical elements.

### BACKGROUND OF THE INVENTION

Optical elements that provide acceptable imaging qualities and popular effects such as tinting, polarization and photochromicity, while maintaining durability and abrasion resistance, are sought for a variety of applications, such as windshields, sunglasses, fashion lenses, non-prescription and prescription lenses, sport masks, face shields and goggles. Responsive to that need, coated optical elements have been developed.

However, the coatings often lack sufficient adhesion to a substrate to provide long wear. Coatings such as photochromic coatings and protective tie-layer coatings have been developed containing adhesion promoters such as epoxides and aminoalkyltrialkoxysilanes to enhance adhesion of coatings to the substrate and/or to subsequently applied coatings. Such adhesion promoters have highly reactive functional groups that may lead to instability and reduced shelf life of coating compositions. Blocked isocyanates have also been used, but when the deblocking temperature of the blocking agent exceeds the curing temperature of the resinous components, the adhesion promoters may not be as effective as necessary.

Many optical substrate manufacturers apply protective coating layers to the substrates during manufacturing. Occasionally these protective layers have poor adhesion to subsequently applied coatings provided by others. Removing the protective layer prior to applying new coatings often poses other problems, such as damage to the substrate.

Additional methods to improve adhesion of coatings to substrates have included surface treatments of the substrates; however, some conventional treatments such as by caustic bath are not suitable for common optical substrates on the market.

There is a need in the art to develop processes for preparing coated optical elements with improved adhesion between the element substrate and the applied coating layers that is suitable for use on bare and protectively coated substrates.

### SUMMARY OF THE INVENTION

In accordance with the present invention, processes for preparing a coated optical element are provided. A typical process comprises:

a) providing an optical element comprising a substrate;

b) contacting at least a portion of the optical element with a pretreatment composition comprising an aqueous solution of hydrolyzed aminosilane; and

c) applying a film-forming composition to at least a portion of the optical element that had been contacted with the pretreatment composition to form a coating on the optical element, thereby yielding a coated optical element. In certain embodiments of the present invention, the pretreatment composition may further comprise a substantially water-miscible solvent that is capable of swelling the substrate surface without causing haze or degradation of the substrate. The coated optical element demonstrates improved adhesion between the film-forming composition and the substrate compared to a substantially identical optical element that has not been contacted with the pretreatment composition of step b) prior to application of the film-forming composition.

### DETAILED DESCRIPTION OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are each understood to be non-limiting with respect to the scope of the invention.

As used in the following description and claims, the following terms have the indicated meanings:

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₅ substituted acrylic acids, such as methacrylic acid, ethacrylic acid, etc., and their C₁-C₅ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer.

The term “cure”, “cured” or similar terms, as used in connection with a cured or curable composition, e.g., a “cured composition” of some specific description, means that at least a portion of the polymerizable and/or crosslinkable components that form the curable composition is at least partially polymerized and/or crosslinked. For example, the degree of crosslinking can range from 5% to 100% of complete crosslinking. In alternate embodiments, the degree of crosslinking can range from 35% to 85%, e.g., 50% to 85%, of full crosslinking. The degree of crosslinking can range between any combination of the previously stated values, inclusive of the recited values.

The term “curable”, as used for example in connection with a curable film-forming composition, means that the indicated composition is polymerizable or cross linkable, e.g., by means that include, but are not limited to, thermal, catalytic, electron beam, chemical free-radical initiation, and/or photoinitiation such as by exposure to ultraviolet light or other actinic radiation.

The terms “on”, “appended to”, “affixed to”, “bonded to”, “adhered to”, or terms of like import means that the designated item, e.g., a coating, film or layer, is either directly connected to (superimposed on) the object surface, or indirectly connected to the object surface, e.g., through one or more other coatings, films or layers (superposed on).

The term “ophthalmic” refers to elements and devices that are associated with the eye and vision, such as but not limited to, lenses for eyewear, e.g., corrective and non-corrective lenses, and magnifying lenses.

The term “optical quality”, as used for example in connection with polymeric materials, e.g., a “resin of optical quality” or “organic polymeric material of optical quality” means that the indicated material, e.g., a polymeric material, resin, or resin composition, is or forms a substrate, layer, film or coating that can be used as an optical article, such as an ophthalmic lens, or in combination with an optical article.

The term “rigid”, as used for example in connection with an optical substrate, means that the specified item is self-supporting.

The term “light influencing function”, “light influencing property” or terms of like import means that the indicated material, e.g., coating, film, substrate, etc., is capable of modifying by absorption (or filtering) of incident light radiation, e.g., visible, ultraviolet (UV) and/or infrared (IR) radiation that impinges on the material. In alternate embodiments, the light influencing function can be light polarization, e.g., by means of a polarizer and/or dichroic dye; a change in light absorption properties, e.g., by use of a chromophore that changes color upon exposure to actinic radiation, such as a photochromic material; transmission of only a portion of the incident light radiation, e.g., by use of a fixed tint such as a conventional dye; or by a combination of one or more of such light influencing functions.

The term “adapted to possess at least one light influencing property”, as used for example in connection with a rigid optical substrate, means that the specified item is capable of having the light influencing property incorporated into or appended to it. For example, a plastic matrix that is adapted to possess a light influencing property means that the plastic matrix has sufficient internal free volume to accommodate internally a photochromic dye or tint. The surface of such a plastic matrix may alternatively be capable of having a photochromic or tinted layer, film or coating appended to it, and/or is capable of having a polarizing film appended to it.

The term “optical substrate” means that the specified substrate exhibits a light transmission value (transmits incident light) of at least 4 percent and exhibits a haze value of less than 1 percent, e.g., less than 0.5 percent, when measured at 550 nanometers by, for example, a Haze Gard Plus Instrument. Optical substrates include, but are not limited to, optical articles such as lenses, optical layers, e.g., optical resin layers, optical films and optical coatings, and optical substrates having a light influencing property.

The term “transparent”, as used for example in connection with a substrate, film, material and/or coating, means that the indicated substrate, coating, film and/or material has the property of transmitting light without appreciable scattering so that objects lying beyond are entirely visible.

The phrase “an at least partial film” means an amount of film covering at least a portion, up to the complete surface of the substrate. As used herein, a “film” may be formed by a sheeting type of material or a coating type of material. For example, a film may be an at least partially cured polymeric sheet or an at least partially cured polymeric coating of the material indicated. The phrase “at least partially cured” means a material in which from some to all of the curable or cross-linkable components are cured, crosslinked and/or reacted.

According to the present invention, a process for preparing a coated optical element is provided, comprising:

a) providing an optical element comprising a substrate;

b) contacting at least a portion of the optical element with a pretreatment composition comprising an aqueous solution of hydrolyzed aminosilane; and

c) applying a film-forming composition to at least a portion of the optical element that had been contacted with the pretreatment composition to form a coating on the optical element, thereby yielding a coated optical element, wherein the coated optical element demonstrates improved adhesion between the film-forming composition and the substrate compared to a substantially identical optical element that has not been contacted with the pretreatment composition of step b) prior to application of the film-forming composition.

Optical elements of the present invention include but are not limited to ophthalmic articles such as piano (without optical power) and vision correcting (prescription) lenses (finished and semi-finished) including multifocal lenses (bifocal, trifocal, and progressive lenses); and ocular devices such as contact lenses and intraocular lenses, sun lenses, fashion lenses, sport masks, face shields and goggles. The optical element may also be chosen from glazings such as windows and vehicular transparencies such as automobile windshields and side windows.

The substrate a) used in the present invention comprises an optical substrate and may comprise, inter alia, polymeric organic materials, oligomeric organic materials, and/or monomeric materials. The substrate may be rigid, i.e., capable of maintaining its shape and supporting any subsequently-applied coatings or films. The optical substrate, including any coatings or treatments applied thereto, may be adapted to possess at least one light influencing property such as tinting, polarization, or photochromicity. In a particular embodiment of the present invention the substrate is a polymeric organic material such as an optically clear polymerizate, e.g., material suitable for optical applications, such as for the manufacture of ophthalmic articles. Such optically clear polymerizates have a refractive index that may vary widely. Examples include polymerizates of optical resins such as thermoplastic polycarbonate and optical resins sold by PPG Industries, Inc. as TRIVEX® lens materials and under the CR- designation, e.g., CR-39® monomer composition. High refractive index polythiourethane substrates available from Mitsui Chemicals Co., Ltd., under the names MR-6, MR-7, MR-8, and MR-10 are also suitable. Non-limiting examples of other suitable substrates are disclosed in U.S. Patent Publication 2004/0096666 in paragraphs [0061], and [0064] to [0081], incorporated herein by reference.

The substrate used in the optical article of the present invention may comprise polymeric organic material chosen from thermoplastic material, thermosetting material, and mixtures thereof. Such materials are described in the Kirk-Othmer Encyclopedia of Chemical Technology, Fourth Edition, Volume 6, pages 669 to 760. Thermoplastic materials can be made substantially thermoplastic or thermosetting by the appropriate chemical modification, as known to those skilled in the art.

Further examples of optical resins that may be used as substrates in the present invention include, but are not limited to the resins used to form hard and soft contact lenses such as are disclosed in U.S. Pat. No. 5,166,345, column 11, line 52, to column 12, line 52, which disclosure is incorporated herein by reference; as well as resins used to form, for example, soft contact lenses with high moisture content as described in U.S. Pat. No. 5,965,630 and extended wear contact lenses as described in U.S. Pat. No. 5,965,631.

Other specific examples of suitable polymeric materials include, but are not limited to polymers of bis(allyl carbonate) monomers; diethylene glycol dimethacrylate monomers; ethoxylated Bisphenol A dimethacrylate monomers; ethylene glycol bismethacrylate monomers; poly(ethylene glycol) bismethacrylate monomers; ethoxylated phenol bismethacrylate monomers; alkoxylated polyhydric alcohol acrylate monomers such as ethoxylated trimethylol propane triacrylate monomers; urethane acrylate monomers. Also suitable are polymers of polyfunctional, e.g., mono-, di-, or multi-functional acrylate and/or methacrylate monomers; poly(C₁-C₁₂ alkyl methacrylates) such as poly(methyl methacrylate); poly(oxyalkylene)dimethacrylate; poly(alkoxylated phenol methacrylates); cellulose acetate; cellulose triacetate; cellulose acetate propionate; cellulose acetate butyrate; poly(vinyl acetate); polyurethanes; polythiourethanes; thermoplastic polycarbonates; polyester; poly(ethylene terephthalate); copolymers of styrene and methyl methacrylate; copolymers of styrene and acrylonitrile; and, particularly, copolymers with poly(allyl carbonate) monomers, e.g., diethylene glycol bis(allyl carbonate), acrylate monomers, e.g., ethyl acrylate, butyl acrylate, polyesters, polyamides, and polyketones. Also contemplated are copolymers of the aforementioned monomers, combinations, and blends of the aforementioned polymers and copolymers with other polymers so as to form, for example, interpenetrating network products.

In various embodiments of the present invention the substrate may be a transparent polymeric material. Suitable examples include LEXAN®, a resin derived from Bisphenol A and phosgene; MYLAR®, a polyester; and PLEXIGLAS®, a poly(methyl methacrylate).

In general, the substrate used as the optical element in the process of the present invention comprises a material containing carbonyl functional groups.

Also, the substrate may include a coating or film on the surface thereof, applied prior to step b) of the process (typically during manufacturing), wherein the coating or film provides protection to the substrate from abrasion or other damage. For example, commercially available thermoplastic polycarbonate optical lenses typically are sold with an abrasion-resistant coating, e.g., a hard coat, already applied to its surface(s) because the surface can be readily scratched, abraded or scuffed during handling or shipping. An example of such articles is the GENTEX polycarbonate lens (available from Gentex Optics) that is sold with a hard coat already applied to the polycarbonate surface.

Prior to step b) of the process of the present invention, the optical element may be cleaned with a cleaning solution such as an aqueous detergent solution, and/or rinsed with water to ensure a clean surface prior to pretreatment.

In step b) of the process of the present invention, at least a portion of the optical element is contacted with a pretreatment composition comprising an aqueous solution of hydrolyzed aminosilane. Contact may be by brushing, dipping (immersion), flow coating, spraying and the like, but typically is by immersion. Immersion may include stirring or other agitation of the pretreatment composition, by use of a stirring device or by movement of the optical element through the composition.

The temperature of the pretreatment composition is typically in the range of 20 to 60° C., such as 25 to 45° C. The optical element may be in contact with the pretreatment composition for a period of 1 to 30 minutes, such as 5 to 15 minutes.

Suitable aminosilanes that may be used in the pretreatment composition include any amino functional organosilanes. Typically the aminosilane comprises an aminoalkyl trialkoxysilane such as aminopropyl triethoxysilane. The silane becomes hydrolyzed upon addition to the aqueous medium. For purposes of the present invention, the hydrolyzed aminosilane may comprise partially hydrolyzed aminosilane, fully hydrolyzed aminosilane, or a mixture thereof. Typically, the hydrolyzed aminosilane used to prepare the pretreatment composition comprises fully hydrolyzed aminosilane. The aminosilane is usually present in the pretreatment composition in an amount ranging from 0.1 to 40 percent by weight, such as 0.5 to 40 percent by weight, or 5 to 40 percent by weight, or 5 to 30 percent by weight, or 10 to 25 percent by weight, based on the total weight of the pretreatment composition.

The pretreatment composition can further comprise a substantially water-miscible solvent that is capable of swelling the substrate surface without causing haze or degradation of the substrate. Suitable solvents include glycol ethers such as ethylene glycol methyl ether and propylene glycol methyl ether, n-methylpyrrolidone, ketones such as acetone and cyclohexanone, alcohols, such as isopropanol, ethanol and/or diacetone alcohol and/or glycol ether acetates. One skilled in the art would understand that the type(s) and amount(s) of such water-miscible solvents used in the pretreatment composition are selected (1) to avoid hazing or degradation of the substrate, and (2) to minimize reaction of the solvent with the aminosilane. In such embodiments, the solvent can be present in the pretreatment composition in an amount of up to and including 50 percent by weight.

In embodiments where the pretreatment composition includes a substantially water-miscible solvent, step b) of the process comprises contacting at least a portion of the optical element with the pretreatment composition at a temperature and for a time at least sufficient to cause swelling of the substrate surface without causing haze or degradation of the substrate. Such temperature and time ranges are usually within those disclosed above, but may be increased or decreased as necessary.

For some applications, the optical element can be contacted with the pretreatment composition in step b) in an environment substantially free of CO₂. A CO₂-free environment may be desirable, for example, where application conditions are conducive to salt formation due to interaction of ionizable groups comprising one of the components of the pretreatment composition (e.g., primary amine groups of the aminosilane) with CO₂ present in the surrounding environment. Such salt formation is undesirable because it can result in the presence of solid particulates in the pretreatment composition which may cause defects on the surface of the optical element and/or negatively impact the effectiveness of the components comprising the pretreatment composition.

For purposes of the present invention, the atmosphere or environment immediately adjacent the pretreatment composition can be substantially free of CO₂ before and after application of the pretreatment composition to the optical element in step b), as well as during such application.

An environment substantially free of CO₂ can be accomplished in any of a wide variety of art-recognized methods for CO₂ removal from gas mixtures. For example, acidic gases such as CO₂ can be removed by an aqueous amine scrubbing process wherein CO₂-containing gas mixtures can be contacted with concentrated amine solutions. Another known method is generally referred to as the aqueous base scrubbing process or “hot pot” process where a small level of an amine is included as an activator for the aqueous base used in the scrubbing solution. Such as method is useful where bulk removal of CO₂ is required. Additionally, a non-aqueous solvent process can be used wherein water is a minor constituent of the scrubbing solution and the amine is dissolved in the liquid phase containing the solvent. One particular aqueous amine scrubbing process employing sterically hindered amines for improved efficiency is described in detail in U.S. Pat. No. 4,112,052. Suitable CO₂ scrubber devices such as models SCS20SII, SCS700SII, SCS1400SII and SCS1800SII, are available from Storage Control Systems, Inc. of Sparta, Mich.

After step b) of the process and prior to application of any subsequent film-forming compositions, the optical element may be subjected to at least one, and often at least two, rinsing steps with deionized water. Such rinsing may include any combination of immersion with or without agitation, spraying, and other effective rinsing techniques. In a typical embodiment, the substrate is immersed in deionized water for up to five minutes with agitation, followed by spray rinsing with additional deionized water.

Following any rinsing steps with deionized water and prior to step c), the optical element may be rinsed with a composition comprising a substantially water-miscible C₁-C₄ alcohol and allowed to dry. Typically isopropanol is used for this optional rinsing step. Drying may be air drying at ambient temperature or may include heat if desired.

In step c) of the process of the present invention, a film-forming composition is applied to at least a portion of the optical element that had been contacted with the pretreatment composition to form a coating on the optical element. In certain embodiments, the coating or film imparts a light influencing property and/or provides protection to the substrate from abrasion or other damage. Examples of suitable abrasion resistant coatings include those disclosed in published U.S. Patent Application No. 2004/0207809, paragraphs [0205]-[0249], incorporated herein by reference. Suitable coatings designed to provide impact resistance include those disclosed in U.S. Pat. No. 5,316,791, col. 3, line 7-col. 7, line 35, the cited portions of which are ncorporated herein by reference. Other suitable coatings and films are discussed in more detail below.

The types of material that may be used for the film or coating vary widely and be chosen from any known in the art. The thickness of the films of polymeric organic materials may also vary widely. The thickness may range, for example, from 0.025 to 100 micrometers (0.001 to 4.0 mils) such as from 0.01 to 50 micrometers and any range of thicknesses between these values, inclusive of the recited values. However, if desired, greater thicknesses may be used.

Polymeric organic materials suitable for use in the film-forming composition may be chosen from thermosetting materials, thermoplastic materials and mixtures thereof. Such materials can include the polymeric organic materials chosen for the substrate. Other non-limiting examples of films of polymeric organic materials are disclosed in U.S. Patent Publication 2004/0096666 in paragraphs [0082] to [0098], the cited portions of which are incorporated herein by reference.

In certain embodiments, the film-forming composition comprises thermoplastic polymeric organic materials chosen from nylon, poly(vinyl acetate), vinyl chloride-vinyl acetate copolymer, poly(C₁-C₈ alkyl)acrylates, poly(C₁-C₈ alkyl)methacrylates, styrene-butadiene copolymer resin, poly(urea-urethanes), polyurethanes, polyterephthalates, polycarbonates, polycarbonate-silicone copolymer, copolymers thereof and mixtures thereof.

Optionally, compatible (chemically and color-wise) fixed tint dyes may be added or applied to the film-forming composition to achieve a more aesthetic result, for medical reasons, or for reasons of fashion. For example, the dye may be selected to complement the color resulting from activated photochromic materials, e.g., to achieve a more neutral color or absorb a particular wavelength of incident light. In another embodiment, the dye may be selected to provide a desired hue to the optical element when the photochromic materials are in an unactivated state. See for example, U.S. Pat. No. 6,042,737 at column 4, line 43 to column 5, line 8, which disclosure related to tinting coated substrates is incorporated herein by reference.

As noted above, the film-forming composition may comprise a protective coating. Examples of protective coatings known in the art that provide abrasion and scratch resistance are chosen from polyfunctional acrylic hard coatings, melamine-based hard coatings, urethane-based hard coatings, alkyd-based coatings and organosilane type coatings. Non-limiting examples of such abrasion resistant coatings are disclosed in U.S. Patent Application 2004/0096666 in paragraphs [0128] to [0149], and in U.S. Patent Application 2004/0207809 in paragraphs [0205] to [0249], the cited portions of which are incorporated herein by reference.

In one embodiment, the film-forming composition comprises an at least partially polarizing coating. The phrase “at least partially polarizing” means that from some to all of the vibrations of the electric field vector of lightwaves is confined to one direction or plane by the coating. Such polarizing effects may be achieved by applying to the optical element a film having an aligned dichroic material to at least partially polarize transmitted radiation. In one non-limiting embodiment, a polymeric sheet is stretched to align the dichroic material applied to the polymeric sheet. In another non-limiting embodiment, a coating is cured in a directional fashion, e.g., using polarized ultraviolet radiation, to align the dichroic materials in the coating.

The film-forming composition can comprise an antireflective coating. Anti-reflective coatings reduce the amount of glare reflected by the surface of the optical element and/or increase the percent transmittance through the optical element as compared to an optical element without an anti-reflective coating. Also, the film forming composition can comprise any of a variety of coatings known for use in conjunction with optical elements. For example, the film-forming coating may comprise an anti-fogging coating, an anti-static coating, an anti-microbial coating, a photocatalytic coating, a self-healing coating, a UV absorbing or reflective coating, an IR absorpbing or reflective coating, a thermochromic coating or an electrochromic coating, or combinations thereof.

The film-forming composition may be applied to the substrate, for example, using any of the methods used in coating technology. Non-limiting examples include spray coating, spin coating, spin and spray coating, spread coating, curtain coating, dip coating, casting-coating, roll-coating, reverse roll coating, transfer roll coating, kiss/squeeze coating, gravure roll coating, blade coating, knife coating, and rod/bar coating. Film-forming compositions comprising, for example, metal oxides, metal fluorides, or other such materials, can be applied by vacuum evaporation or sputtering.

When the film-forming composition is curable, following application of the curable film-forming composition to the surface of the substrate, any solvent used to prepare the curable film-forming composition may be evaporated.

Methods used for curing the curable film-forming composition can include solvent evaporation, radical polymerization, thermal curing, photopolymerization or a combination thereof. Additional methods include irradiating the polymerizable material with infrared, ultraviolet, gamma or electron radiation so as to initiate the polymerization reaction of any polymerizable components, or to initiate crosslinking mechanisms. This may be followed by a heating step.

The present invention is more particularly described in the following examples that are intended as illustration only, since numerous modifications and variations therein will be apparent to those skilled in the art.

### EXAMPLES

Eight examples, four comparative examples and two controls that are non-silane containing compositions for enhancing adhesion to polymer surfacesare provided below.

In Part 1 of each example and comparative example, the preparation of the composition is described. Part 2 describes the preparation of the substrates prior to the treatment procedure which is described in Part 3. The coating procedure is described in Part 4 and the adhesion testing is described in Part 5. When abrasion resistance testing was done, it is described in Part 6.

### Example 1

### Part 1—Preparation of Example Compositions

Aminopropyltriethoxysilane (323 grams), obtained as A1100 from OSi Specialties, was added very slowly and with adequate stirring to a reaction vessel containing 677 grams of deionized (DI) water. The contents were cooled with an ice/water bath. The temperature of the contents of the reaction vessel was maintained between 20-30° C. for one hour after the addition of A1100 was completed. The resulting aminopropylsilanetriol solution was approximately 20 weight percent, based on the total weight of the solution.

### Part 2—Preparation of Substrates Prior to Treatment with Examples

Substrates were cleaned with a sponge or soft cloth in warm, soapy water, and rinsed thoroughly with DI water.

### Part 3—Example Treatment Procedure

Six uncoated polycarbonate bifocal lenses obtained from GENTEX were cleaned as described in Part 2 and were immersed into a beaker containing Example 1 which was heated to 50° C. using a hot plate with stirring. The stirring was stopped during the immersion of the lenses. After the lenses were immersed for 15 minutes, they were removed and rinsed thoroughly with DI water followed by a final rinse with anhydrous isopropyl alcohol (IPA).

### Part 4—Coating Procedure

Two of the lenses from Part 3 were spin coated at 900 rpm with Hi-Gard® 1600 sold by PPG Industries, Inc. and cured at 120° C. for 3 hours. Approximately 2.5 grams of material was dispensed during the coating process to produce a cured coating having a thickness of approximately 3 microns. Another two lenses were spin coated at 900 rpm with a polyurethane coating composition of the type described in Examples 1-10 of U.S. Pat. No. 6,187,444B1 except that photochromic material was not included and the coated lenses were cured at 140° C. for one hour. Approximately 2.5 grams of material was dispensed during the coating process to produce a cured coating having a thickness of approximately 10 microns. The final two lenses were spin coated at 900 rpm with a microparticle coating composition crosslinked with melamine of the type described in Examples 10-13 of U.S. Patent Publication 2006/0014099, except that photochromic material was not included and the coated lenses were cured at 140° C. for one hour. Approximately 2.5 grams of material was dispensed during the coating process to produce a cured coating having a thickness of approximately 10 microns.

### Part 5—Adhesion Testing

A modified ASTM D-3359-93 Standard Test Method for Measuring Adhesion by Tape Test—Method B was used. The standard method was modified to include a primary dry test followed by a secondary wet test done after the sample was held in boiling water for two hours. If a lens did not pass the primary dry test it was not included in the secondary wet test.

All six lenses were tested for adhesion and demonstrated 100 percent adhesion in both the primary dry test and secondary wet test.

### Example 2

### Part 1—Preparation of Example Compositions

Aminopropylsilanetriol reported to be 22-25 weight percent, based on the total weight of the aqueous solution, was obtained as SIA0608.0 from Gelest, Inc. and used as supplied.

### Part 2—Preparation of Substrates Prior to Treatment with Examples

The procedure of Example 1 was followed.

### Part 3—Example Treatment Procedure

Two uncoated polycarbonate bifocal lenses obtained from GENTEX, that were cleaned as described in Part 2 were immersed into a beaker containing Example 2 that was heated to 50° C. After the lenses were immersed for 15 minutes, they were removed and rinsed thoroughly with DI water followed by a final rinse with anhydrous isopropyl alcohol (IPA).

### Part 4—Coating Procedure

The lenses from Part 3 were dip coated with Hi-Gard® 1600 sold by PPG Industries, Inc. at a withdrawl rate of 230 mm/min resulting in a 5 micron thick film on both sides of the lens after curing for 3 hours at 120° C.

### Part 5—Adhesion Testing

The lenses were tested for adhesion using the procedure described in Part 5 of Example 1. Both lenses demonstrated 100 percent adhesion in both the primary dry test and secondary wet test with only slight crazing, i.e., fine cracks in the coating, after the secondary boiling water exposure.

### Examples 3 and 4

### Part 1—Preparation of Example Compositions

Example 3 was prepared by mixing 1000 grams of Example 2 and 1000 grams of DI water to result in an approximately 11-12.5 weight percent solution of aminopropylsilanetriol.

Example 4 was prepared by mixing 500 grams of Example 2 and 1000 grams of DI water to result in an approximately 7.3-8.3 weight percent solution of aminopropylsilanetriol.

### Part 2—Preparation of Substrates Prior to Treatment with Examples

The procedure of Example 1 was followed.

### Part 3—Example Treatment Procedure

Forty-five GENTEX barrier coated polycarbonate finished 6 base piano lenses purchased from Three Rivers Optical, that were cleaned as described in Part 2 were used in the following manner. Amounts of each Example 2, 3 and 4, sufficient in which to immerse a lens were added to 3 beakers. The filled beakers were each heated to 22° C., 30° C. and 50° C. in a Branson 5200 ultrasonic bath set to full sonication. Each of the lenses was immersed into a beaker of a different example for a time interval of 1, 3, 5, 10 and 15 minutes. Afterwards, the lenses were removed and rinsed thoroughly with DI water followed by a final rinse with anhydrous isopropyl alcohol (IPA).

### Part 4—Coating Procedure

The lenses from Part 3 were dip coated with Hi-Gard® 1600 following the procedure of Part 4 of Example 2.

### Part 5—Adhesion Testing

21 of the 45 lenses were tested for adhesion using the procedure described in Part 5 of Example 1. All lenses demonstrated 100 percent adhesion in both the primary dry test and secondary wet test.

### Part 6—Abrasion Resistance Testing

All 45 of the lenses were submitted for abrasion resistance using the Colts Laboratories Bayer Abrasion Test SOP #L-11-10-06. The lenses ranged in abrasion resistance testing from the lowest reported result of 4 to from the highest reported result of 4.84 times that of uncoated lenses prepared from CR-39® monomer.

### Examples 5, 6 and 7

### Part 1—Preparation of Example Compositions

Example 5 was prepared by the addition of 30 grams of CONTRAD® 70 obtained from Decon Laboratories, to 1000 grams of Example 2.

Example 6 was prepared by the addition of 50 grams of CONTRAD® 70 obtained from Decon Laboratories, to 1000 grams of Example 2.

Example 7 was prepared by the addition of 50 grams of CONTRAD® 70 obtained from Decon Laboratories, to 1000 grams of Example 2.

### Part 2—Preparation of Substrates Prior to Treatment with Examples

The procedure of Example 1 was followed.

### Part 3—Example Treatment Procedure

Six GENTEX barrier coated polycarbonate finished 6 base piano lenses purchased from Three Rivers Optical that were cleaned as described in Part 2 were used in the following manner. Amounts of each Example 5, 6 and 7, sufficient in which to immerse a lens were added to 2 beakers. One of two beakers for each example was kept at ambient temperature in a Branson 5200 ultrasonic bath set to full sonication and the other was placed in the ultrasonic bath set to full sonication and heated to 50° C. Each of the lenses was immersed into a beaker of a different example and temperature for a time interval of 7.5 minutes. Afterwards, the lenses were removed and rinsed thoroughly with DI water followed by a final rinse with anhydrous isopropyl alcohol (IPA).

### Part 4—Coating Procedure

The lenses from Part 3 were dip coated with Hi-Gard® 1600 following the procedure of Part 4 of Example 2.

### Part 5—Adhesion Testing

Adhesion testing was not performed on these lenses.

### Part 6—Abrasion Resistance Testing

All of the lenses from Part 4 were submitted for abrasion resistance using the Colts Laboratories Bayer Abrasion Test SOP #L-11-10-06 which test method is incorporated herein by reference. The lenses ranged in abrasion resistance testing from the lowest reported result of 3.83 to the highest reported result of 4.17 times that of uncoated lenses prepared from CR-39® monomer.

### Example 8

### Part 1—Preparation of Example Compositions

Example 8 was prepared by the addition of 1000 grams of DOWANOL® PM obtained from Dow, to 1000 grams of Example 2.

### Part 2—Preparation of Substrates Prior to Treatment with Examples

The procedure of Example 1 was followed. Part 3—Example Treatment Procedure

Two semi-finished uncoated polycarbonate lenses obtained from Younger Optics were immersed into a beaker of Example 8 held at ambient temperature. The lens of Example 8A was immersed for 5 minutes and the lens of 8B was immersed for 15 minutes. Afterwards, the lenses were removed and rinsed thoroughly with DI water followed by a final rinse with anhydrous isopropyl alcohol (IPA).

### Part 4—Coating Procedure

The lenses from Part 3 were dip coated with Hi-Gard® 1600 following the procedure of Part 4 of Example 2. In addition to the lenses designated 8A and 8B, lenses that were immersed in Example 2 for 5 minutes and 15 minutes were also dip coated with Hi-Gard® 1600. These lenses were designated 2A and 2B, respectively. An additional lens that had been immersed for 5 minutes in 12.5 percent sodium hydroxide maintained at 50 C was also dip coated with Hi-Gard® 1600. This lens was designated Control 1.

### Part 5—Adhesion Testing

The lenses were tested for adhesion using the procedure described in Part 5 of Example 1. The results are listed below.

| Example # | Primary Adhesion | Secondary Adhesion |
|---|---|---|
| Control 1 | 0 | — |
| 2A | 100 | 0 |
| 2B | 100 | 100 |
| 8A | 100 | 100 |
| 8B | 100 | 100 |

### Comparative Examples 1-4

### Part 1—Preparation of Comparative Example Compositions

Comparative Example 1 was prepared by slowly adding 55.5 grams of a nitric acid solution prepared by the addition of 1 gram of 70 percent nitric +acid in 7,000 grams of DI water to a beaker containing 243 grams of gamma-glycidoxypropyltrimethoxysilane. After hydrolysis was complete, evident by a clearing of the solution and the peaking of the exothermic reaction, the pH of the solution was adjusted with tetramethylammonium hydroxide to approximately 5.0. 701.5 Grams of DI water was added to the reaction mixture to produce a solution having approximately 20 percent solids, based on the total weight of the solution.

Comparative Example 2 was prepared following the procedure used to prepare Comparative Example 1 except that gamma-methacryloxypropyltrimethoxysilane was used.

Comparative Example 3 was prepared by slowly adding 70 grams of the nitric acid solution prepared in Comparative Example 1 to a beaker containing 255 grams of mercaptopropyltrimethoxysilane. After the initial hydrolysis, the pH of the solution was adjusted with tetramethylammonium hydroxide to approximately 5.0. 675 Grams of DI water was added to the reaction mixture to produce a solution of approximately 20 percent solids, based on the total weight of the solution.

Comparative Example 4 was prepared by slowly adding 107 grams of the nitric acid solution prepared in Comparative Example 1 to a beaker containing 295 grams of vinylpropyltrimethoxysilane. After the initial hydrolysis, the pH of the solution was adjusted with tetramethylammonium hydroxide to approximately 5.0. 598 Grams of DI water were added to the reaction mixture to produce a solution of approximately 20 percent solids, based on the total weight of the solution.

### Part 2—Preparation of Substrates Prior to Treatment with Comparative Examples

The procedure of Example 1 was followed.

### Part 3—Comparative Example Treatment Procedure

One semi-finished uncoated polycarbonate lens from Younger Optics and one semi-finished uncoated6 base piano lens prepared from CR-39® monomer and obtained from Three Rivers Optical were used for each Comparative Example and Example. Each pair of lenses was immersed for 30 minutes into a beaker of the individual Comparative Examples or Example 2 held at ambient temperature. These lenses were designated Comparative Example (CE) #A or Example 2C for uncoated polycarbonate and CE #B or 2D for the lens made from CR-39® monomer. An additional pair of lens was immersed for 30 minutes in a beaker of 29 percent sodium hydroxide maintained at ambient temperature. These lenses were designated Control 2A for uncoated polycarbonate and Control 2B for the lens made from CR-39® monomer. After immersion, the lenses were removed and rinsed thoroughly with DI water followed by a final rinse with anhydrous isopropyl alcohol (IPA).

### Part 4—Coating Procedure

The lenses from Part 3 were dip coated with Hi-Gard® 1600 following the procedure of Part 4 of Example 2 except that the withdrawal rate was 100 mm/min to produce a cured coating thickness of from 3 to 5 microns.

### Part 5—Adhesion Testing

The lenses were tested for adhesion using the procedure described in Part 5 of Example 1 except that the Secondary Adhesion was tested after one hour in boiling water. The adhesion test results are listed below.

| Example # | Primary Adhesion | Secondary Adhesion |
|---|---|---|
| Control 2A | Surface hazed⁽¹⁾ | — |
| Control 2B | 100 | 0 |
| Example 2C | 100 | 100 |
| Example 2D | 100 | 100 |
| CE 1A | 0 | — |
| CE 1B | 0 | — |
| CE 2A | 0 | — |
| CE 2B | 0 | — |
| CE 3A⁽³⁾ | 0 | — |
| CE 3B⁽³⁾ | 0 | — |
| CE 4A⁽⁴⁾ | Surface “melted”⁽²⁾ | — |
| CE 4B⁽⁴⁾ | 0 | — |

⁽¹⁾The “hazed” surface showed some light scattering that was detected by visual observation.
⁽²⁾The ”melted” surface showed a distorted surface that was tacky to the touch.
⁽³⁾The solution of Comparative Example 3 separated shortly after the lenses were immersed.
⁽⁴⁾The solution of Comparative Example 4 separated shortly after the solution of Comparative Example 4.

Whereas particular embodiments of this invention have been described above for purposes of illustration, it will be evident to those skilled in the art that numerous variations of the details of the present invention may be made without departing from the invention as defined in the appended claims.

What is claimed is:

1. A process for preparing a coated optical element comprising:
a) providing an optical element comprising a substrate;
b) contacting at least a portion of the optical element with a pretreatment composition comprising an aqueous solution of hydrolyzed aminosilane; and
c) applying a film-forming composition to at least a portion of the optical element that had been contacted with the pretreatment composition to form a coating on the optical element, thereby yielding a coated optical element, wherein the coated optical element demonstrates improved adhesion between the film-forming composition and the substrate compared to a substantially identical optical element that has not been contacted with the pretreatment composition of step b) prior to application of the film-forming composition.

2. The process of claim 1 wherein the substrate comprises a material containing carbonyl functional groups.

3. The process of claim 2 wherein the substrate comprises polycarbonate, acrylic, polyurethane urea, and/or polyamide polymers.

4. The process of claim 3 wherein the substrate comprises polycarbonate that has been coated with a protective coating prior to step b).

5. The process of claim 1, wherein the optical element comprises a lens.

6. The process of claim 1, wherein the aminosilane comprises an aminoalkyl trialkoxysilane.

7. The process of claim 6 wherein the aminoalkyl trialkoxysilane comprises aminopropyl triethoxysilane.

8. The process of claim 1, wherein the aminosilane is present in the pretreatment composition in an amount of 5 to 40 percent by weight, based on the total weight of the pretreatment composition.

9. The process of claim 1 wherein the temperature of the pretreatment composition is in the range of 20 to 60° C.

10. The process of claim 1 wherein the optical element is in contact with the pretreatment composition for 1 to 30 minutes.

11. The process of claim 1 wherein prior to step b), the optical element is cleaned with an aqueous detergent solution and rinsed with water.

12. The process of claim 1 wherein following step b) and prior to step c), the optical element is subjected to at least one rinsing step with deionized water.

13. The process of claim 12 wherein following the rinsing step with deionized water and prior to step c), the optical element is rinsed with a composition comprising a substantially water-miscible C₁-C₄ alcohol and allowed to dry.

14. The process of claim 13 wherein the C₁-C₄ alcohol comprises isopropanol.

15. The process of claim 1 wherein the pretreatment composition further comprises a substantially water-miscible solvent that is capable of swelling the substrate surface without causing haze or degradation of the substrate.

16. The process of claim 15 wherein the solvent comprises a glycol ether, n-methylpyrrolidone, acetone, cyclohexanone, and/or glycol ether acetates.

17. The process of claim 15 wherein the solvent is present in the pretreatment composition in an amount of up to 50 percent by weight.

18. A process for preparing a coated optical element comprising:
a) providing an optical element comprising a substrate;
b) contacting at least a portion of the optical element with a pretreatment composition comprising an aqueous solution of hydrolyzed aminosilane and a substantially water-miscible solvent, at a temperature and for a time that are at least sufficient to cause swelling of the substrate surface without causing haze or degradation of the substrate; and
c) applying a film-forming composition to at least a portion of the optical element that had been contacted with the pretreatment composition to form a coating on the optical element, thereby yielding a coated optical element, wherein the coated optical element demonstrates improved adhesion between the film-forming composition and the substrate compared to a substantially identical optical element that has not been contacted with the pretreatment composition of step b) prior to application of the film-forming composition.

19. The process of claim 1, wherein in (b), the optical element is contacted with the pretreatment composition in an environment substantially free of CO₂.

20. The process of claim 18, wherein in (b), the optical element is contacted with the pretreatment composition in an environment substantially free of CO₂.

21. The process of claim 1, wherein the hydrolyzed aminosilane comprises fully hydrolyzed aminosilane.

22. The process of claim 18, wherein the hydrolyzed aminosilane comprises fully hydrolyzed aminosilane.

23. A coated optical element prepared by the process of claim 1.

24. A coated optical element prepared by the process of claim 18.
